(19) United States
(12) Patent Application Publication
(10) Pub. No.: US 2025/0178275 A1
(43) Pub. Date: Jun. 5, 2025

(54) ADDITIVE MANUFACTURING USING OVERLAY FIDUCIAL FEATURE TEMPLATE MATCHING

(71) Applicant: Evolve Additive Solutions, Inc., Minnetonka, MN (US)

(72) Inventor: Andrew Rice, Chaska, MN (US)

(21) Appl. No.: 18/758,487

(22) Filed: Jun. 28, 2024

Related U.S. Application Data
(60) Provisional application No. 63/524,527, filed on Jun. 30, 2023.

(51) Int. Cl. B29C 64/141; B29C 64/236; B29C 64/393; B33Y 10/00; B33Y 30/00; B33Y 50/02

(52) U.S. Cl. CPC B29C 64/141; B29C 64/236; B29C 64/393; B33Y 10/00; B33Y 30/00; B33Y 50/02

(57) ABSTRACT

A system and method for printing a 3D part is disclosed. The method includes forming a material toner image on a transfer medium including a registration pattern comprising at least three features (the features combined to form a fiducial); transporting the material toner image on the transfer medium to a sensor such that the features may be detected by the sensor; storing a position measurement for each feature detected by the sensor; calculating a score for subsets of features with reference to a template; adjusting the relative position of the transfer medium and a build surface based on at least the positions of the selected features; and transferring the toner image from the transfer medium to the build surface.

This application claims the benefit of U.S. Provisional Application No. 63/524,527, filed Jun. 30, 2023, the content of which is herein incorporated by reference in its entirety.

### FIELD

Embodiments herein relate to additive manufacturing, including selective thermoplastic electrophotographic process (STEP) systems and use of imaging technology to register components and deposited materials.

### BACKGROUND

The present disclosure relates to systems and methods for additive manufacturing of three-dimensional (3D) parts, and more particularly, to additive manufacturing systems and processes for building 3D parts and their support structures.

Additive manufacturing systems are used to build 3D parts from digital representations of the parts (e.g., AMF and STL format files) using one or more additive manufacturing techniques. Examples of commercially available additive manufacturing techniques include extrusion-based techniques, ink jetting, selective laser sintering, powder/binder jetting, electron-beam melting, and stereolithographic processes. For each of these techniques the digital representation of the 3D part is initially sliced into multiple horizontal toner images. For each sliced toner image, a tool path is then generated, which provides instructions for the particular additive manufacturing system to form the given toner image.

In an electrophotographic 3D printing process, each slice of the digital representation of the 3D part and its support structure is printed or developed using an electrophotographic engine. The electrophotographic engine uses charged powder materials that are formulated for use in building a 3D part (e.g., a polymeric toner material). The electrophotographic engine typically uses a support drum that is coated with a photoconductive material toner image, where latent electrostatic images are formed by electrostatic charging following image-wise exposure of the photoconductive toner image by an optical source. The latent electrostatic images are then moved to a developing station where the polymeric toner is applied to charged areas, or alternatively to discharged areas of the photoconductive insulator to form the toner image of the charged powder material representing a slice of the 3D part. The developed toner image is transferred to a transfer medium, from which the toner image is transfused to previously printed toner images with heat and pressure to build the 3D part.

Selective Thermoplastic Electrophotographic Process (STEP) systems use separate print engines to lay down material (toner). For example, one engine can lay down part material while another lays down support material It is important that the toner material be laid down precisely so that the toner material is aligned properly with the part material that has already been deposited. The method disclosed here is concerned with alignment of a toner layer with the part, sometimes called layer-to-layer (L2L) registration or “Overlay” registration.

However, such measurement is not always robust for poorly formed, e.g. porous, features. Defects in feature formation are especially prevalent in builds with larger number of engines, as back-transfer of material degrades the fiducial quality. As the result, registration control can fail to perform its function, and part quality suffers, both in terms of dimensional accuracy & surface quality.

Therefore, there is a strong need for improved registration systems and methods of toner material on the transfer medium of STEP systems and processes.

### SUMMARY

The present application is directed, in part, to a method for printing a three-dimensional part on a build surface, and to methods for improving registration of material as it is transferred to the build surface. In particular, the method allows for adjustments in registration along the direction of travel of the build surface (the x-direction), and can optionally be used in the cross-travel direction (or y-direction).

The methods of the present disclosure include, in various embodiments, the steps of: a) forming a material toner image on a transfer medium (such as a belt) including a registration pattern comprising a fiducial having at least three features; b) transporting the toner image on the transfer medium to a sensor such that the features of the registration pattern may be detected by the sensor; c) detecting one or more of the features; d) storing a position measurement for each artifact that feature detected by the sensor (an artifact can be, for example, an intended feature, or an unintended element or toner deposit, or even a wrinkle or defect in the transfer belt); e) calculating a score for subsets of features with reference to a template; f) adjusting the relative position of the transfer medium and a build surface based on the positions of the selected features; and g) transferring the toner image from the transfer medium to the build surface.

It will be understood that there in practice there are challenges to detecting the various feature. The challenges can arise, for example, when a feature does not print properly, such as by lacking sharp edges or having inadequate interior coverage of material. These improperly printed features, which may be intended as lines or rectangles, can appear to have a shifted edge and/or even appear as more than one feature (such as when the interior lacks adequate material so that two features are detected rather than one). In addition, there can be undesirable residue on the transfer medium that shows up as a feature where none is intended. The present application includes methods, with various algorithms, for identifying a preferred fit for the fiducial ideally a “best” fit that is used as feedback for the making of adjustments in the x-direction of the relative position of the transfer medium and the build platform.

Two categories of errors include false readings by the sensor, in which inaccurate detection and measurement occurs, and missed readings by the sensor, in which there is a failure to detect and measure. This disclosure seeks to address both issues. The disclosure seeks to filter out false readings (regardless of the source) by comparing actual readings (and their relative locations) to expectations. Additionally, determination of correct readings can be used to fill-in missing readings. In certain implementations, the method for printing a three-dimensional part further comprises transfusing the transferred toner image to a part forming on the build surface, which is (for example) an empty build sheet at the start of the build process, or a part (with part and support material) that is being created.

In certain implementations, the method further comprises repeatedly detecting one or more features for each toner image.

In certain implementations, the method includes repeatedly calculating a score for subsets of features with reference to a template (such as a number of center-to-center spacings for feature lines forming a fiducial).

In certain implementations, the material toner image comprises part material.

In certain implementations, the material toner image comprises support material.

In certain implementations the registration pattern comprises four or more features.

In certain implementations, the registration pattern is positioned to correspond to one quadrant of the toner image.

In certain implementations, the registration pattern is positioned to correspond to two quadrants of the toner image.

In certain implementations, the registration pattern is positioned to correspond to three quadrants of the toner image.

In certain implementations, the registration pattern is positioned to correspond to four quadrants of the toner image.

In certain implementations, the transfer medium comprises a belt.

In certain implementations, the three features are identical to one another.

In certain implementations, the three features are different from one another. In an example implementation a single fiducial contains three features, such as lines that are spaced from one another with gaps between them. Optionally those gaps are different from one another to help with matching.

In certain implementations, the sensor comprises an imaging sensor.

In certain implementations, the sensor comprises an optical sensor.

In certain implementations, the sensor comprises a laser sensor.

In certain implementations, the imaging sensor comprises a camera.

In certain implementations, the sensor comprises a capacitive sensor.

In certain implementations, the method for printing a three-dimensional part comprises creating a template with “n” features, where n>3.

In certain implementations, the method for printing a three-dimensional part includes various individual steps, which can be varied or modified. In some implementations, those steps can include recording a list of N=C₂ⁿ target gap sizes. In certain implementations, recording a list of N=C₂ⁿ target gap sizes comprises: {x₁, x₂, . . . x_{N}}, collecting “m” measurements from the sensor; and identifying M=Cₙ^{m} subsets, retaining the measurement order.

In certain implementations, identifying M=Cₙ^{m} subsets comprises:

$$\begin{matrix}[ \{ {y}_{1 , 1} , {y}_{1 , 2} , … {y}_{1 , n} \} \\ \{ {y}_{2 , 1} , {y}_{2 , 2} , … {y}_{2 , n} \} \\ … \\ \{ {y}_{M , 1} , {y}_{M , 2} , … {y}_{M , n} \} ]\end{matrix}$$

In certain implementations, method includes making measured gap sizes for each subset of “n” measurements

$$\begin{matrix}[ \{ {z}_{1 , 1} , {z}_{1 , 2} , … {z}_{1 , N} \} \\ \{ {z}_{2 , 1} , {z}_{2 , 2} , … {z}_{2 , N} \} \\ … \\ \{ {z}_{M , 1} , {z}_{M , 2} , … {z}_{M , N} \} ]\end{matrix}$$

In certain implementations, the method includes calculating the difference between the target gaps and the measured gaps for each subset of measurements

$$\begin{matrix}[ \{ {x}_{1} - {z}_{1 , 1} , {x}_{2} - {z}_{1 , 2} , … {x}_{N} - {z}_{1 , N} \} \\ \{ {x}_{1} - {z}_{2 , 1} , {x}_{2} - {z}_{2 , 2} , … {x}_{N} - {z}_{2 , N} \} \\ … \\ \{ {x}_{1} - {z}_{M , 1} , {x}_{2} - {z}_{M , 2} , … {x}_{N} - {z}_{M , N} \} ]\end{matrix}$$

scoring each subset, sorting the subsets by score and selecting the lowest score, comparing the lowest score to a threshold, and reducing the number of target features to match to n−1.

In certain implementations, the method includes looking for partial matches and then interpolating or extrapolating the positions of the missing features.

In certain implementations, the method includes averaging the positions of each feature.

In certain implementations, the method further comprises calculating an overlay adjustment based on the average position of the features.

In certain implementations, the method includes incorporating additional criteria including feature width.

In certain implementations, the method further comprises incorporating additional criteria including feature absolute location.

In certain implementations, the method further comprising incorporating additional criteria including feature position toner image-to-toner image. For example, once a “score” has been calculated for a subset of artifacts with reference to the intended fiducial location, it is possible to reject a subset of artifacts if the position is far different from what has been observed on previous toner images. The threshold can be changed based on the size of the subset. To reduce false positives, it is possible to lower the threshold (i.e. make it more stringent) which would require the partial match to the template to be better than when we were needing to match all the features.

This could be done entirely independently from the use of “additional criteria” described in the last two paragraphs.

Unless otherwise specified, the following terms as used herein have the meanings provided below:

The terms “at least one” and “one or more of” an element are used interchangeably, and have the same meaning that includes a single element and a plurality of the elements, and may also be represented by the suffix “(s)” at the end of the element. For example, “at least one polyamide”, “one or more polyamides”, and “polyamide(s)” may be used interchangeably and have the same meaning.

The terms “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

Directional orientations such as “above”, “below”, “top”, “bottom”, and the like are made with reference to a direction along a printing axis of a 3D part. In the embodiments in which the printing axis is a vertical z-axis, the toner image-printing direction is the upward direction along the vertical z-axis. In these embodiments, the terms “above”, “below”, “top”, “bottom”, and the like are based on the vertical z-axis. However, in embodiments in which the toner images of 3D parts are printed along a different axis, the terms “above”, “below”, “top”, “bottom”, and the like are relative to the given axis.

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability.

The term “selective deposition” refers to an additive manufacturing technique where one or more toner images of particles are fused to previously deposited toner images utilizing heat and pressure over time where the particles fuse together to form a toner image of the part and also fuse to the previously printed toner image.

The term “electrostatography” refers to the formation and utilization of latent electrostatic charge patterns to form an image of a toner image of a part, a support structure or both on a surface. Electrostatography includes, but is not limited to, electrophotography where optical energy is used to form the latent image, ionography where ions are used to form the latent image and/or electron beam imaging where electrons are used to form the latent image.

Unless otherwise specified, temperatures referred to herein are based on atmospheric pressure (i.e. one atmosphere).

The terms “about” and “substantially” are used herein with respect to measurable values and ranges due to expected variations known to those skilled in the art (e.g., limitations and variabilities in measurements).

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a simplified diagram of an exemplary electrophotography-based additive manufacturing system for printing 3D parts and associated support structures, in accordance with embodiments of the present disclosure.

FIG. 2 is a schematic front view of electrophotographic engines, in accordance with exemplary embodiments of the present disclosure, including a transfer medium.

FIG. 3 is a schematic front view of an exemplary electrophotographic engine, which includes a transfer drum and belt, in accordance with exemplary embodiments of the present disclosure.

FIG. 4 is a schematic front view of an exemplary electrophotographic engine, which includes a transfer belt, in accordance with exemplary embodiments of the present disclosure, and further including a camera for detection of feature features.

FIG. 5 is a top view of an example toner image of material, showing slice content and a registration pattern of features.

FIG. 6A is a representation of a perfectly formed feature.

FIG. 6B is a representation of an imperfectly formed feature.

FIG. 6C is a representation of an imperfectly formed feature.

FIG. 6D is a representation of an imperfectly formed feature.

FIG. 7 is a diagram showing features, digital outputs, and artifact center positions.

FIG. 8 is a diagram showing features, digital outputs, and artifact center positions.

FIG. 9 is a flowchart of a method in accordance with various embodiments herein.

FIG. 10 is a flowchart of a method in accordance with various embodiments herein.

FIG. 11 is a flowchart of a method in accordance with various embodiments herein.

FIG. 12 is a flowchart of a method in accordance with various embodiments herein.

FIG. 13 is a flowchart of a method in accordance with various embodiments herein.

FIG. 14 is a flowchart of a method in accordance with various embodiments herein.

FIG. 15 is a flowchart of a method in accordance with various embodiments herein.

FIG. 16 is a flowchart of a method in accordance with various embodiments herein.

FIG. 17 is a flowchart of a method in accordance with various embodiments herein.

FIG. 18 is a flowchart of a method in accordance with various embodiments herein.

FIG. 19 is a flowchart of a method in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Embodiments of the disclosure are described more fully hereinafter with reference to the accompanying drawings. Elements that are identified using the same or similar reference characters refer to the same or similar elements. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

Specific details are given in the following description to provide a thorough understanding of the embodiments. However, it is understood by those of ordinary skill in the art that the embodiments may be practiced without these specific details. For example, circuits, systems, networks, processes, frames, supports, connectors, motors, processors, and other components may not be shown, or shown in block diagram form in order to not obscure the embodiments in unnecessary detail.

The present application is directed, in part, to a method for printing a 3D part comprising forming a toner image of part or support material on a transfer medium including a registration pattern. The registration pattern typically includes at least three features. The toner image of part or support material is transported on the transfer medium to a sensor such that the features (typically at least three) of the registration pattern may be detected by the sensor. The positional measurement is stored for each feature detected by the sensor. A score is calculated for subsets of features with reference to a template. The transfer medium and build surface are subsequently adjusted with their relative position of the transfer medium and a build surface based on at least the positions of the selected features. Thereafter the material toner image is transferred from the transfer medium to the build surface.

Thus, the present application is directed, in part, to methods relating to a system for “overlay” sensing that is robust to various common errors. Overlay sensing is the primary source of data for layer to layer control, which is primarily a feed-forward control in which a feature is detected prior to transfusion and the x-stage makes a motion correction based on that measurement. Any error in the measurement can result in a significant part quality defect, and the present disclosure provides methods for reducing such error and thereby improving part quality.

Two categories of errors include false readings by the sensor, in which inaccurate detection and measurement occurs, and missed readings by the sensor, in which there is a failure to detect and measure. This disclosure seeks to address both issues. The disclosure seeks to filter out false readings (regardless of the source) by comparing actual readings (and their relative locations) to expectations. Additionally, determination of correct readings can be used to fill-in missing readings.

Potential sources of false readings include contamination due to toner or other debris, back-transfer or forward-transfer of toner, belt wrinkles or creases, etc. Also, if features are of non-uniform density, it is possible to “double-trigger” on the same feature. If a back-up roller is used, debris on the back up roller can trigger the sensor by locally deforming the belt. In some cases electromagnetic interference (EMI) or other electrical sources may introduce noise. Missed readings are usually caused if the toner density is too low, which itself can be due to several causes.

An example procedure is thus summarized as follows:
1. Create a template with “n” features, where n>3.
2. Record a list of N=C₂ⁿ target gap sizes.
   {x₁, x₂, . . . x_{N}}
3. Collect “m” measurements of artifacts from the sensor. An artifact is something detected by the sensor that can potentially be considered as toner. For example, an artifact can be an intended feature, or an unintended element or toner deposit, or even a wrinkle or defect in the transfer belt. In other words, artifacts are things detected by the sensor and which need to be evaluated to determine whether they are actual features of a fiducial or are not features of a fiducial.
4 Identify M=Cₙ^{m} subsets (retaining the measurement order)

$$\begin{matrix}[ \{ {y}_{1 , 1} , {y}_{1 , 2} , … {y}_{1 , n} \} \\ \{ {y}_{2 , 1} , {y}_{2 , 2} , … {y}_{2 , n} \} \\ … \\ \{ {y}_{M , 1} , {y}_{M , 2} , … {y}_{M , n} \} ]\end{matrix}$$

5. Calculate the measured gap sizes for each subset of “n” measurements

$$\begin{matrix}[ \{ {z}_{1 , 1} , {z}_{1 , 2} , … {z}_{1 , N} \} \\ \{ {z}_{2 , 1} , {z}_{2 , 2} , … {z}_{2 , N} \} \\ … \\ \{ {z}_{M , 1} , {z}_{M , 2} , … {y}_{M , N} \} ]\end{matrix}$$

6. Calculate the difference between the target gaps and the measured gaps for each subset of measurements

$$\begin{matrix}[ \{ {x}_{1} - {z}_{1 , 1} , {x}_{2} - {z}_{1 , 2} , … {x}_{N} - {z}_{1 , N} \} \\ \{ {x}_{1} - {z}_{2 , 1} , {x}_{2} - {z}_{2 , 2} , … {x}_{N} - {z}_{2 , N} \} \\ … \\ \{ {x}_{1} - {z}_{M , 1} , {x}_{2} - {z}_{M , 2} , … {x}_{N} - {z}_{M , N} \} ]\end{matrix}$$

7. Score each subset using, e.g. root-mean-square

$$\begin{matrix}[ \{ {s}_{1} \} \\ \{ {s}_{2} \} \\ … \\ \{ {s}_{M} \} ]\end{matrix}$$

8. Sort the subsets by score and select the lowest score.
9. Compare the lowest score to a threshold. If below the threshold, a good fit has been found. Skip to step 13. If the best fit is above the threshold, there is no complete match. Search for a partial match.
10. Reduce the number of target features to match to n−1. For each gap in the N′=C₂ⁿ⁻¹ target gap sizes
   {x₁, x₂, . . . x_{N′}}
11. Repeat 4-10 until n=1 or a good partial fit has been found.
12. For partial matches, interpolate or extrapolate the positions of the missing features
13. Average the positions of each missing feature corresponding to the fiducial.
14. Calculate an overlay adjustment based on the average position of the features

Additional options include, for example in step 9, use of additional criteria in addition to the score calculated in step 7. Other criteria may include: feature width, absolute location of the feature, or relative position to previous toner images. The options listed here include additional attributes of the data (i.e. in addition to conformance to the fiducial) that may be used to determine a score for a subset of artifacts. A scenario in which this is very useful is when there is no subset of “n” measurements that match the fiducial, in which case, according to the method, it is possible consider subsets of size “n−1” and look for a partial match. Since the fewer features that need to be matched, the more likely it is to get a false match, so therefore it is helpful to have additional criteria against which one can score the subset of artifacts. This can reduce the chances of a false match.

If the best scoring subset of artifacts fails when considering the additional criteria (such as prior toner images), look at the next lowest score. If it is still below the threshold, again apply the additional criteria above. If this fails again, look at the next best score. Continue until scores exceed the threshold or all subsets fail.

If the system matches three artifacts with three lines below a certain score threshold, it is not necessary to apply additional pass/fail criteria. However, if the system matches only two artifacts with two of the target lines, it is possible to apply the additional criteria. This is because of the increased uncertainty in the original match. It is also possible to use different scoring thresholds for when a match is made to all 3 lines vs only 2 lines.

Other implementations include where there is considerable flexibility in how many features to match, the feature size/shape/layout, the sensing technology, the thresholds, and various criteria used to calculate and evaluate a score.

While the present disclosure can be utilized with any electrostatography-based additive manufacturing system, the present disclosure will be described in association in an electrophotography-based (EP) additive manufacturing system. However, the present disclosure is not limited to an EP based additive manufacturing system and can be utilized with any electrostatography-based additive manufacturing system.

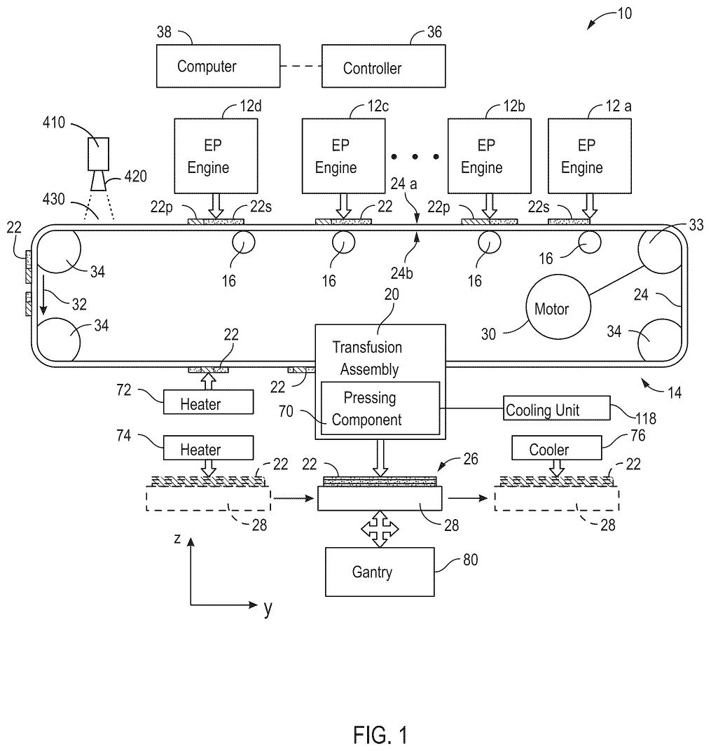

Now in reference to the figures, FIG. 1 is a simplified diagram of an exemplary electrophotography-based additive manufacturing system 10 for printing 3D parts and associated support structures in a toner image-by-toner image manner, in accordance with embodiments of the present disclosure. While illustrated as printing 3D parts and associated support structures in a toner image-by-toner image manner, the system 10 can also be used to form stacks of toner images and transfuses the stacks to form the 3D parts and associated support structures.

As shown in FIG. 1, system 10 includes one or more electrophotographic (EP) engines, generally referred to as 12, such as EP engines 12a-d, a transfer assembly 14, at least one biasing mechanism 16, and a transfusion assembly 20. Examples of suitable components and functional operations for system 10 include those disclosed in Hanson et al., U.S. Pat. Nos. 8,879,957 and 8,488,994, and in Comb et al., U.S. Publication Nos. 2013/0186549 and 2013/0186558.

The EP engines 12 are imaging engines for respectively imaging or otherwise developing completed toner images of the 3D part, which are generally referred to as 22, of the charged powder part and support materials. The charged powder part and support materials are each preferably engineered for use with the particular architecture of the EP engines 12. In some embodiments, at least one of the EP engines 12 of the system 10, such as EP engines 12a and 12c, develops toner images of the support material to form the support structure portions 22s of a toner image 22, and at least one of the EP engines 12, such as EP engines 12b and 12d, develops toner images of the part material to form the part portions 22p of the toner image 22. The EP engines 12 transfer the formed part portions 22p and the support structure portions 22s to a transfer medium 24. In some embodiments, the transfer medium is in the form of a transfer belt, as shown in FIG. 1. The transfer medium (such as belt 24) may take on other suitable forms in place of, or in addition to, the transfer belt, such as a transfer drum. Accordingly, embodiments of the present disclosure are not limited to the use of transfer mediums in the form of the transfer belt 24.

In some embodiments, the system 10 includes at least one pair of the EP engines 12, such as EP engines 12a and 12b, which cooperate to form completed toner images 22. In some embodiments, additional pairs of the EP engines 12, such as EP engines 12c and 12d, may cooperate to form other toner images 22.

In some embodiments, each of the EP engines 12 that is configured to form the support structure portion 22s of a given toner image 22 is positioned upstream from a corresponding EP engine 12 that is configured to form the part portion 22p of the toner image 22 relative to the feed direction 32 of the transfer belt 24. Thus, for example, EP engines 12a and 12c that are each configured to form the support structure portions 22s are positioned upstream from their corresponding EP engines 12b and 12d that are configured to form the part portions 22p relative to the feed direction 32 of the transfer belt 24, as shown in FIG. 1. In alternative embodiments, this arrangement of the EP engines 12 may be reversed such that the EP engines that form the part portions 22p may be located upstream from the corresponding EP engines 12 that are configured to form the support structure portions 22s relative to the feed direction 32 of the transfer belt 24. Thus, for example, the EP engine 12b may be positioned upstream from the EP engine 12a, and the EP engine 12d may be positioned upstream of the EP engine 12c relative to the feed direction 32 of the transfer belt 24.

As discussed below, the developed toner images 22 are transferred to a transfer medium 24 of the transfer assembly 14, which delivers the toner images 22 to the transfusion assembly 20. The transfusion assembly 20 operates to build a 3D structure 26, which includes the 3D part 26p, support structures 26s and/or other features, in a toner image-by-toner image manner by transfusing the toner images 22 together on a build platform 28.

In some embodiments, the transfer medium includes a belt 24, as shown in FIG. 1. Examples of suitable transfer belts for the transfer medium (such as belt 24) include those disclosed in Comb et al. (U.S. Publication Nos. 2013/0186549 and 2013/0186558). In some embodiments, the belt 24 includes front surface 24a and rear surface 24b, where front surface 24a faces the EP engines 12, and the rear surface 24b is in contact with the biasing mechanisms 16.

In some embodiments, the transfer assembly 14 includes one or more drive mechanisms that include, for example, a motor 30 and a drive roller 33, or other suitable drive mechanism, and operate to drive the transfer medium or belt 24 in a feed direction 32. In some embodiments, the transfer assembly 14 includes idler rollers 34 that provide support for the belt 24. The exemplary transfer assembly 14 illustrated in FIG. 1 is highly simplified and may take on other configurations. Additionally, the transfer assembly 14 may include additional components that are not shown in order to simplify the illustration, such as, for example, components for maintaining a desired tension in the belt 24, a belt cleaner for removing debris from the surface 24a that receives the toner images 22, and other components.

System 10 also includes a controller 36, which represents one or more processors that are configured to execute instructions, which may be stored locally in memory of the system 10 or in memory that is remote to the system 10, to control components of the system 10 to perform one or more functions described herein. In some embodiments, the processors of the controller 36 are components of one or more computer-based systems. In some embodiments, the controller 36 includes one or more control circuits, microprocessor-based engine control systems, one or more programmable hardware components, such as a field programmable gate array (FPGA), and/or digitally-controlled raster imaging processor systems that are used to control components of the system 10 to perform one or more functions described herein. In some embodiments, the controller 36 controls components of the system 10 in a synchronized manner based on printing instructions received from a host computer 38 or from another location, for example.

In some embodiments, controller 36 communicates over suitable wired or wireless communication links with the components of the system 10. In some embodiments, the controller 36 communicates over a suitable wired or wireless communication link with external devices, such as the host computer 38 or other computers and servers, such as over a network connection (e.g., local area network (LAN) connection), for example.

In some embodiments, the host computer 38 includes one or more computer-based systems that are configured to communicate with the controller 36 to provide the print instructions (and other operating information). For example, the host computer 38 may transfer information to the controller 36 that relates to the sliced toner images of the 3D parts and support structures, thereby allowing the system 10 to print the toner images 22 and form the 3D part including any support structures in a toner image-by-toner image manner. As discussed in greater detail below, in some embodiments, the controller 36 also uses signals from one or more sensors to assist in properly registering the printing of the part portion 22p and/or the support structure portion 22s with a previously printed corresponding support structure portion 22s or part portion 22p on the belt 24 to form the individual toner images 22.

The components of system 10 may be retained by one or more frame structures. Additionally, the components of system 10 may be retained within an enclosable housing that prevents components of the system 10 from being exposed to ambient light during operation.

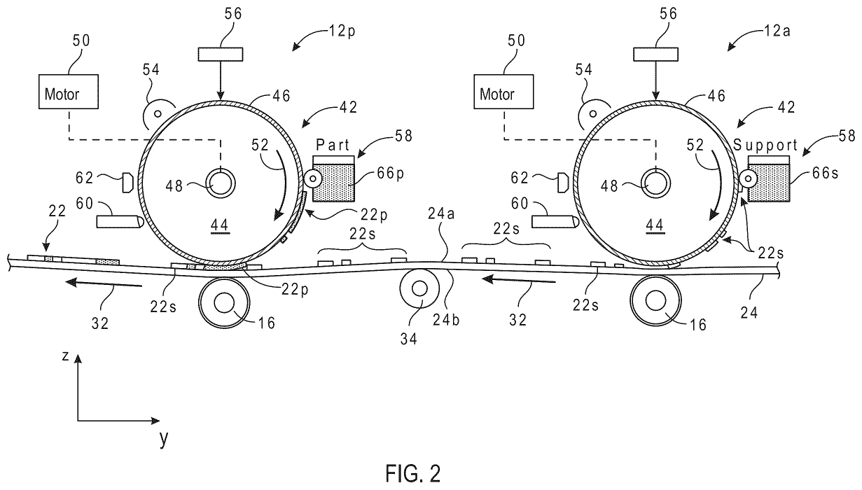

FIG. 2 is a schematic front view of the EP engines 12a and 12b of the system 10, in accordance with exemplary embodiments of the present disclosure. In the shown embodiment, the EP engines 12a and 12b may include the same components, such as a photoconductor drum 42 having a conductive body 44 and a photoconductive surface 46. The conductive body 44 is an electrically-conductive body (e.g., fabricated from copper, aluminum, tin, or the like), that is electrically grounded and configured to rotate around a shaft 48. The shaft 48 is correspondingly connected to a drive motor 50, which is configured to rotate the shaft 48 (and the photoconductor drum 42) in the direction 52, as shown by an arrow at a substantially constant rate. While embodiments of the EP engines 12 are discussed and illustrated as utilizing a photoconductor drum 42, a belt having a conductive material, or other suitable bodies, may also be utilized in place of the photoconductor drum 42 and the conductive body 44.

The photoconductive surface 46 is a thin film extending around the circumferential surface of the conductive body 44 (shown as a drum but can alternatively be a belt or other suitable body), and is preferably derived from one or more photoconductive materials, such as amorphous silicon, selenium, zinc oxide, organic materials, and the like. As discussed below, the surface 46 is configured to receive latent-charged images of the sliced toner images of a 3D part or support structure (or negative images), and to attract charged particles of the part or support material to the charged or discharged image areas, thereby creating the toner images 22 of the 3D part 26p, or support structure 26s.

As further shown, each of the exemplary EP engines 12a and 12b also includes a charge inducer 54, an imager 56, a development station 58, a cleaning station 60, and a discharge device 62, each of which may be in signal communication with the controller 36. The charge inducer 54, the imager 56, the development station 58, the cleaning station 60, and the discharge device 62 accordingly define an image-forming assembly for the surface 46, while the drive motor 50 and the shaft 48 rotate the photoconductor drum 42 in the direction 52.

The EP engines 12 use the charged particle material (e.g., polymeric or thermoplastic toner), generally referred to herein as 66, to develop or form the toner images 22. In some embodiments, the image-forming assembly for the surface 46 of the EP engine 12a is used to form support structure portions 22s of the support material 66s, where a supply of the support material 66s may be retained by the development station 58 (of the EP engine 12a) along with carrier particles. Similarly, the image-forming assembly for the surface 46 of the EP engine 12b is used to form part portions 22p of the part material 66p, where a supply of the part material 66p may be retained by the development station 58 (of the EP engine 12b) along with carrier particles.

The charge inducer 54 is configured to generate a uniform electrostatic charge on the surface 46 as the surface 46 rotates in the direction 52 past the charge inducer 54. Suitable devices for the charge inducer 54 include corotrons, scorotrons, charging rollers, and other electrostatic charging devices.

The imager 56 is a digitally-controlled, pixel-wise light exposure apparatus configured to selectively emit electromagnetic radiation toward the uniform electrostatic charge on the surface 46 as the surface 46 rotates in the direction 52 past the imager 56. The selective exposure of the electromagnetic radiation to the surface 46 is directed by the controller 36 and causes discrete pixel-wise locations of the electrostatic charge to be removed (i.e., discharged), thereby forming latent image charge patterns on the surface 46.

Suitable devices for the imager 56 include scanning laser (e.g., gas or solid-state lasers) light sources, light emitting diode (LED) array exposure devices, and other exposure devices conventionally used in 2D electrophotography systems. In alternative embodiments, suitable devices for the charge inducer 54 and the imager 56 include ion-deposition systems configured to selectively directly deposit charged ions or electrons to the surface 46 to form the latent image charge pattern. In accordance with this embodiment, the charge inducer 54 may be eliminated. In some embodiments, the electromagnetic radiation emitted by the imager 56 has an intensity that controls the amount of charge in the latent image charge pattern that is formed on the surface 46. As such, as used herein, the term “electrophotography” can broadly be considered as “electrostatography,” or a process that produces a charge pattern on a surface. Alternatives also include such things as ionography.

Each development station 58 is an electrostatic and magnetic development station or cartridge that retains the supply of the part material 66p or the support material 66s, along with carrier particles. The development stations 58 may function in a similar manner to single or dual component development systems and toner cartridges used in 2D electrophotography systems. For example, each development station 58 may include an enclosure for retaining the part material 66p or the support material 66s, and carrier particles. When agitated, the carrier particles generate triboelectric charges to attract the powders of the part material 66p or the support material 66s, which charges the attracted powders to a desired sign and magnitude, as discussed below.

Each development station 58 may also include one or more devices for transferring the charged particles of the support material 66p or 66s to the surface 46, such as conveyors, fur brushes, paddle wheels, rollers, and/or magnetic brushes. For instance, as the surface 46 (containing the latent charged image) rotates from the imager 56 to the development station 58 in the direction 52, the charged part material 66p or the support material 66s is attracted to the appropriately charged regions of the latent image on the surface 46, utilizing either charged area development or discharged area development (depending on the electrophotography mode being utilized). This creates successive toner images 22p or 22s on the surface 46 as the photoconductor drum 42 continues to rotate in the direction 52, where the successive toner images 22p or 22s correspond to the successive sliced toner images of the digital representation of the 3D part or support structure.

In some embodiments, the thickness of the toner images 22p or 22s on the surface 46 depends on the charge of the latent image charge pattern on the surface. Thus, the thickness of the toner images 22p or 22s may be controlled through the control of the magnitude of the charge in the pattern on the surface using the controller 36. For example, the controller 36 may control the thickness of the toner images 22p or 22s by controlling the charge inducer 54, by controlling the intensity of the electromagnetic radiation emitted by the imager 56, or by controlling the duration of exposure of the surface 46 to the electromagnetic radiation emitted by the imager 56, for example.

The successive toner images 22p or 22s are then rotated with the surface 46 in the direction 52 to a transfer region in which toner images 22p or 22s are successively transferred from the photoconductor drum 42 to the belt 24 or another transfer medium, as discussed below. While illustrated as a direct engagement between the photoconductor drum 42 and the belt 24, in some preferred embodiments, the EP engines 12a and 12b may also include intermediary transfer drums and/or belts, as discussed further below.

After a given toner image 22p or 22s is transferred from the photoconductor drum 42 to the belt 24 (or an intermediary transfer drum or belt), the drive motor 50 and the shaft 48 continue to rotate the photoconductor drum 42 in the direction 52 such that the region of the surface 46 that previously held the toner image 22p or 22s passes the cleaning station 60. The cleaning station 60 is a station configured to remove any residual, non-transferred portions of part or support material 66p or 66s. Suitable devices for the cleaning station 60 include blade cleaners, brush cleaners, electrostatic cleaners, vacuum-based cleaners, and combinations thereof.

After passing the cleaning station 60, the surface 46 continues to rotate in the direction 52 such that the cleaned regions of the surface 46 pass the discharge device 62 to remove any residual electrostatic charge on the surface 46, prior to starting the next cycle. Suitable devices for the discharge device 62 include optical systems, high-voltage alternating-current corotrons and/or scorotrons, one or more rotating dielectric rollers having conductive cores with applied high-voltage alternating-current, and combinations thereof.

The biasing mechanisms 16 are configured to induce electrical potentials through the belt 24 to electrostatically attract the toner images 22s and 22p from the EP engines 12a and 12b to the belt 24. Because the toner images 22s and 22p are each only a single toner image increment in thickness at this point in the process, electrostatic attraction is suitable for transferring the toner images 22s and 22p from the EP engines 12a and 12b to the belt 24. In some embodiments, the thickness of the toner images 22p or 22s on the surface 24a of the belt 24 depends on the electrical potential induced through the belt by the corresponding biasing mechanism 16. Thus, the thickness of the toner images 22p or 22s may be controlled by the controller 36 through the control of the magnitude of the electrical potential induced through the belt by the biasing mechanisms 16.

The controller 36 preferably controls the rotation of the photoconductor drums 42 of the EP engines 12a and 12b at the same rotational rates that are synchronized with the line speed of the belt 24 and/or with any intermediary transfer drums or belts. This allows the system 10 to develop and transfer the toner images 22s and 22p in coordination with each other from separate developer images. In particular, as shown, each part of the toner image 22p may be transferred to the belt 24 with proper registration with each support toner image 22s to produce a combined part and support material toner image, which is generally designated as toner image 22. As can be appreciated, some of the toner images 22 transferred to the toner image transfusion assembly 20 may only include support material 66s, or may only include part material 66p, depending on the particular support structure and 3D part geometries and toner image slicing.

In an alternative embodiment, the part portions 22p and the support structure portions 22s may optionally be developed and transferred along the belt 24 separately, such as with alternating toner images 22s and 22p. These successive, alternating toner images 22s and 22p may then be transferred to the toner image transfusion assembly 20, where they may be transfused separately to print or build the structure 26 that includes the 3D part 26p, the support structure 26f, and/or other structures.

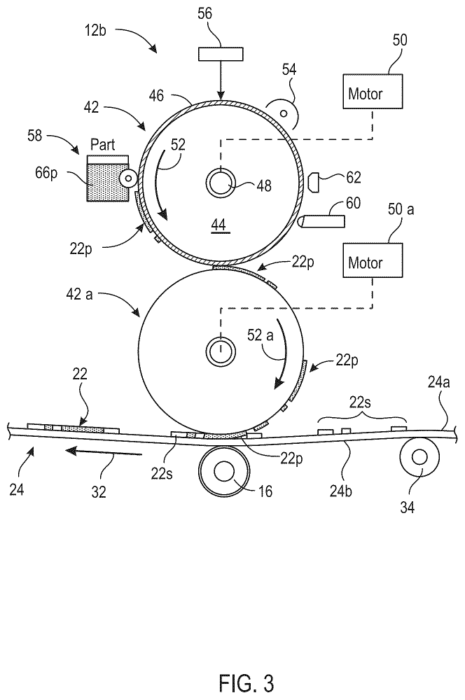

In a further alternative embodiment, one or both of the EP engines 12a and 12b may also include one or more transfer drums and/or belts between the photoconductor drum 42 and the belt or transfer medium (such as belt 24). For example, as shown in FIG. 3, the EP engine 12b may also include a transfer drum 42a that rotates in the direction 52a that opposes the direction 52, in which drum 42 is rotated, under the rotational power of motor 50a. The transfer drum 42a engages with the photoconductor drum 42 to receive the developed toner images 22p from the photoconductor drum 42, and then carries the received developed toner images 22p and transfers them to the belt 24.

The EP engine 12a may include the same arrangement of a transfer drum 42a for carrying the developed toner images 22s from the photoconductor drum 42 to the belt 24. The use of such intermediary transfer drums or belts for the EP engines 12a and 12b can be beneficial for thermally isolating the photoconductor drum 42 from the belt 24, if desired.

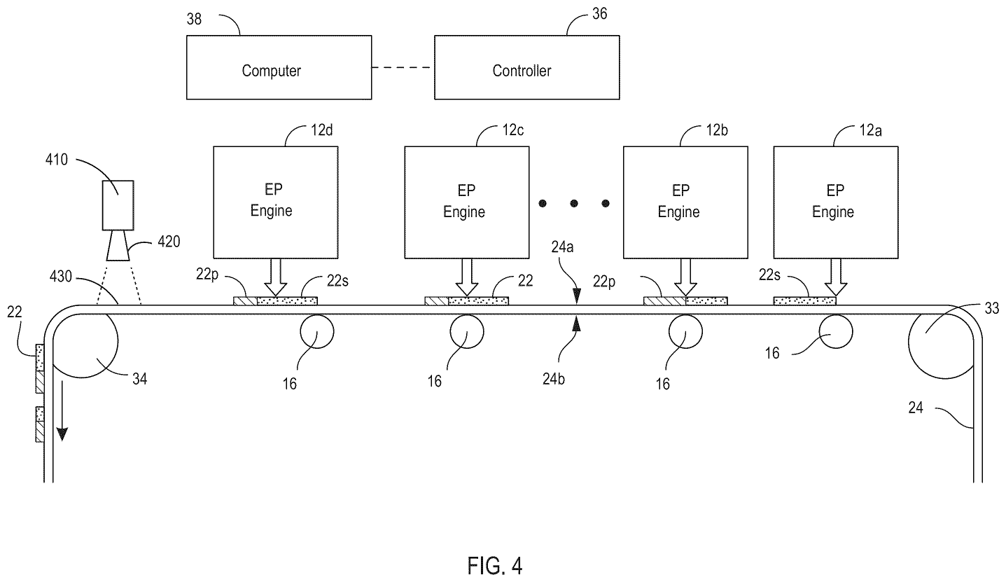

FIG. 4 is a schematic front view of an exemplary electrophotographic assembly, which includes a transfer belt 24, in accordance with exemplary embodiments of the present disclosure, and further including a camera for detection of features. The EP engines 12a to 12b are imaging engines for respectively imaging or otherwise developing completed toner images of the 3D part, which are generally referred to as 22, of the charged powder part and support materials. The charged powder part and support materials are each preferably engineered for use with the particular architecture of the EP engines 12. In some embodiments, at least one of the EP engines 12 of the system 10, such as EP engines 12a and 12c, develops toner images of the support material to form the support structure portions 22s of a toner image 22, and at least one of the EP engines 12, such as EP engines 12b and 12d, develops toner images of the part material to form the part portions 22p of the toner image 22. The EP engines 12 transfer the formed part portions 22p and the support structure portions 22s to a transfer medium 24. In some embodiments, each of the EP engines 12 that is configured to form the support structure portion 22s of a given toner image 22 is positioned upstream from a corresponding EP engine 12 that is configured to form the part portion 22p of the toner image 22 relative to the feed direction 32 of the transfer belt 24. Thus, for example, EP engines 12a and 12c that are each configured to form the support structure portions 22s are positioned upstream from their corresponding EP engines 12b and 12d that are configured to form the part portions 22p relative to the feed direction 32 of the transfer belt 24, as shown in FIG. 1.

The developed toner images 22 are transferred to a transfer medium 24 of the transfer assembly 14. The developed toner images 22 move from right to left in FIG. 4 on the transfer medium 24 (which in this case is a belt). The developed toner images subsequently pass within the field of view of camera 410, having lens 420 with imaging area 430. Camera 410 images the transfer medium 24 and the part portions 22p and support portions 22s, including features that are deposited, to determine registration of the printed materials.

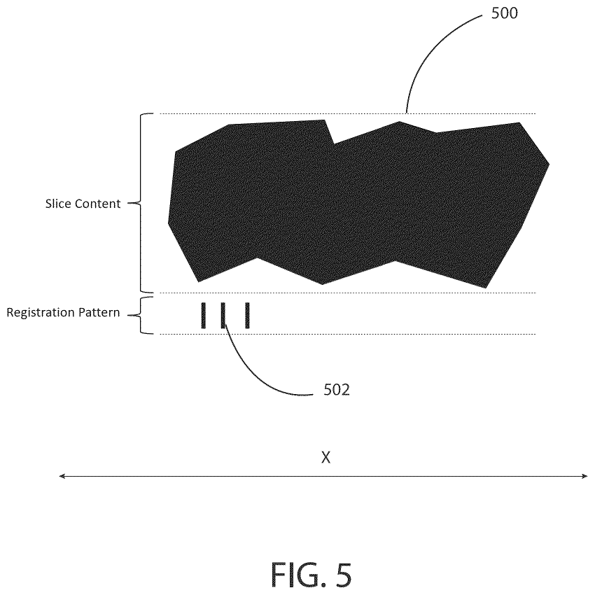

FIG. 5 is a top view of an example toner image of material, showing slice content and a registration pattern of features. The slice content 500 is shown adjacent to the registration pattern 502 of features. In this embodiment the registration pattern 502 is shown as three lines, in this case in one quartile (for example) of the build platform. The X-axis is shown as well and is the axis of travel of the material (such as part or support material) on transfer medium (such a belt). The present system and method allow for adjustments of the position of the transfer medium relative to a build surface so as to provide precise alignment on the x-axis, typically by adjusting of the build surface (rather than the transfer medium).

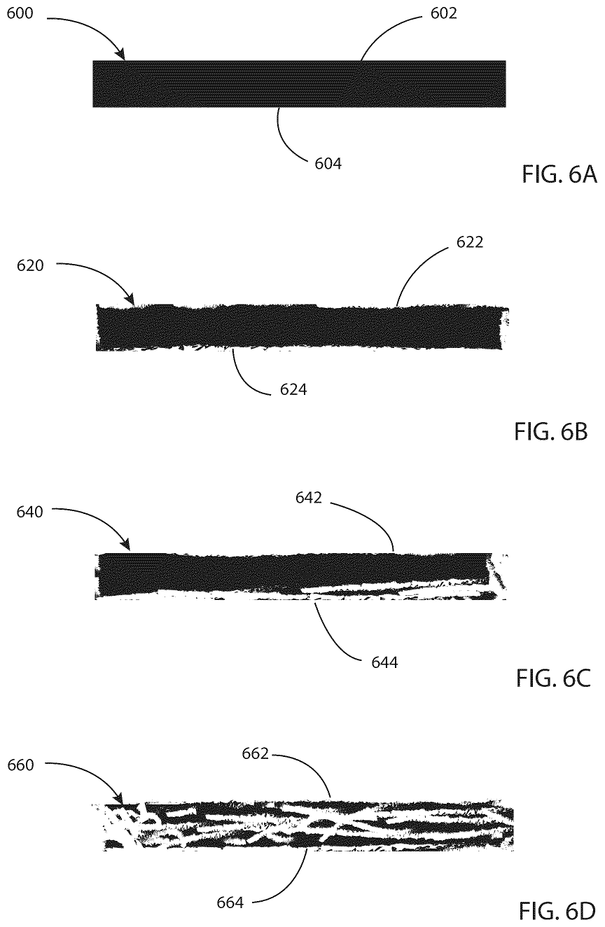

FIG. 6A is a representation of a ideally formed feature 600, showing a rectangular feature with a first edge 602 and a second edge 604. In practice the feature 600 would be aligned on the transfer medium with (for example) the first edge 602 travelling ahead of the second edge 604 (see FIG. 5 for example orientation). It will be appreciated that this ideally formed feature 600 can be realized in some implementations, but the high number of printed toner images means that generally at least some features will have a less precise formation, such as those shown below in FIG. 6B to 6D.

FIG. 6B is a representation of an imperfectly formed feature 620 with first edge 622 and second edge 624. This feature 620 has somewhat irregular edges 622, 624. This irregularity can result in improper determination of the location of the feature. For example, the detected feature can appear to be in a positive or negative relative position on the x-axis if the edges are not precise. An example of this would be where one or both of edges 622, 624 are slightly mis-aligned (or difficult to detect), resulting in an erroneous detected location of the feature.

FIG. 6C is a representation of an imperfectly formed feature shows an even more extreme case where the feature 640 with first edge 642 and second edge 644 show irregularity. In particular, the right side of the second edge 644 is significantly lacking in material. If a measurement is made in that location for the edge of the feature it is likely that the second edge 644 will be measured to be much closer to the first edge 642 than is correct (so the second edge 644 would be detected as closer to the actual center than is appropriate).

FIG. 6D is a representation of an imperfectly formed feature 660 with first edge 662 and second edge 664. In this case the amount of material is much less than intended, and the edges are irregular. Detection of this feature may be challenge, and even if detected the location may be inaccurate.

Thus, as shown in FIG. 6A to 6D, actual features can be quite different than expected features, and a need exists for improved detection and analysis of features to give as accurate as possible measure of the feature locations.

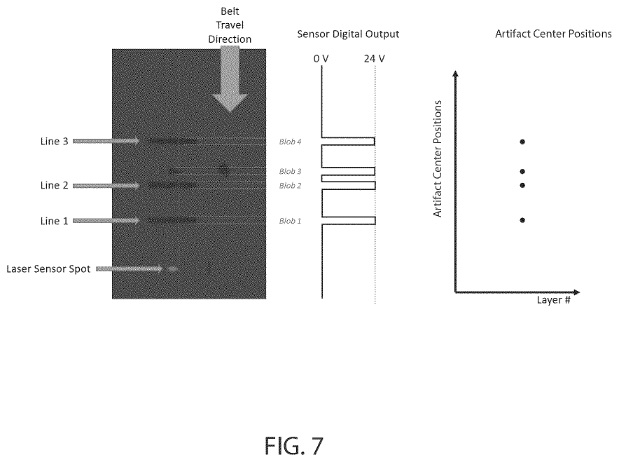

Reference is now made to FIG. 7. In this case the transfer belt travels from the top of the page to the bottom. Three different features are formed, shown as Line 1, Line 2, and Line 3. In addition, excess material is shown between line 2 and line 3. The detector (in this case a laser detector) records four different “artifacts” center positions corresponding to the three features plus the excess unintended material. This results in four different reported “features” shown as dots. In fact there are three intended features. The present application provides a means for reviewing the features and seeking to match them to the intended locations (such as eliminating the detected artifact that is not an intended feature).

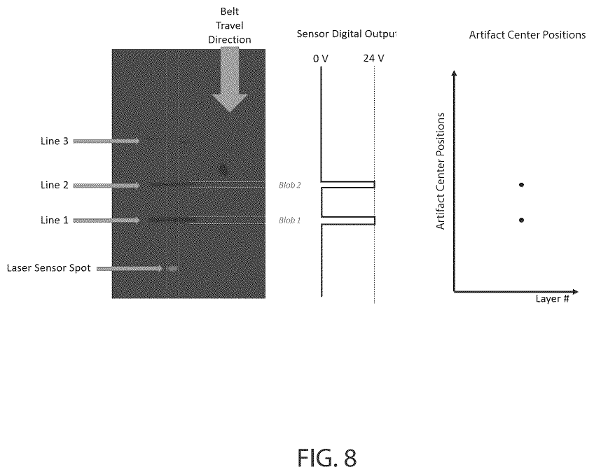

FIG. 8 is also diagram showing features, digital outputs, and artifact center positions, similar to FIG. 7, but in this case only two of the intended features are detected.

The present disclosure is directed to accurate measurement of location of the transfer medium in various situations, such as those that are represented by FIG. 7 and FIG. 8, as well as other situations.

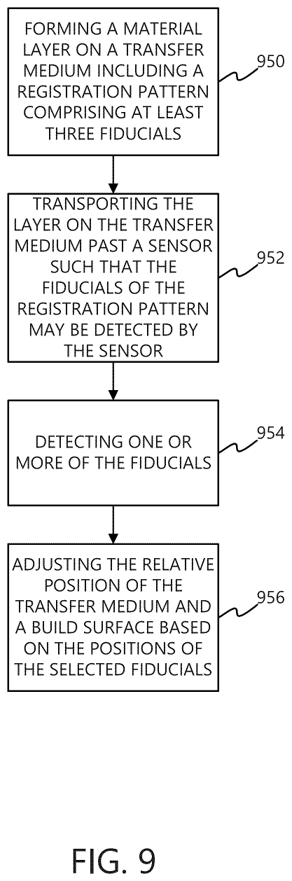

Example algorithms are shown and described throughout this disclosure, but FIGS. 9 to 19 give some example iterations for acceptable methodologies. FIG. 9 is a flowchart of a method in accordance with various embodiments herein, showing steps that include, without limitation, forming a material toner image on a transfer medium including a registration pattern comprising at least three features 950; transporting the toner image on the transfer medium to a sensor such that the features of the registration pattern may be detected by the sensor 952; detecting one or more of the features 954; adjusting the relative position of the transfer medium and a build surface based on the positions of the selected features 956.

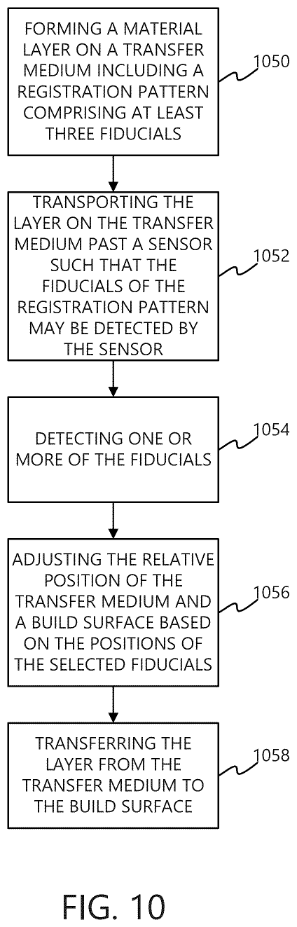

FIG. 10 is a flowchart of a method in accordance with various embodiments herein, showing steps that include, without limitation, forming a material toner image on a transfer medium including a registration pattern comprising at least three features 1050; transporting the toner image on the transfer medium to a sensor such that the features of the registration pattern may be detected by the sensor 1052; detecting one or more of the features 1054; adjusting the relative position of the transfer medium and a build surface based on the positions of the selected features 1056; transferring the toner image from the transfer medium to the build surface 1058.

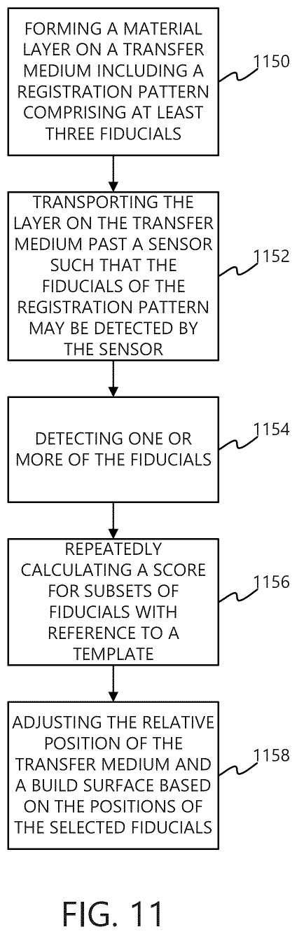

FIG. 11 is a flowchart of a method in accordance with various embodiments herein, showing steps that include, without limitation, forming a material toner image on a transfer medium including a registration pattern comprising at least three features 1150; transporting the toner image on the transfer medium to a sensor such that the features of the registration pattern may be detected by the sensor 1152; detecting one or more of the fiducials 1154; repeatedly calculating a score 1156; adjusting the relative position of the transfer member 1158.

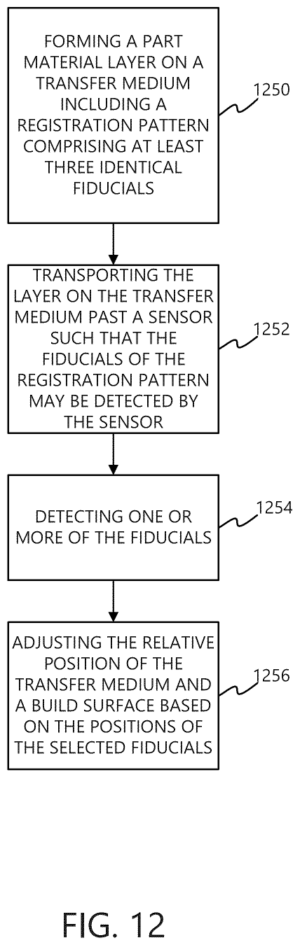

FIG. 12 is a flowchart of a method in accordance with various embodiments herein, showing steps that include, without limitation, forming a part material toner image on a transfer medium including a registration pattern comprising at least three identical features 1250; transporting the toner image on the transfer medium to a sensor such that the features of the registration pattern may be detected by the sensor 1252; detecting one or more of the features 1254; adjusting the relative position of the transfer medium and a build surface based on the positions of the selected features 1256.

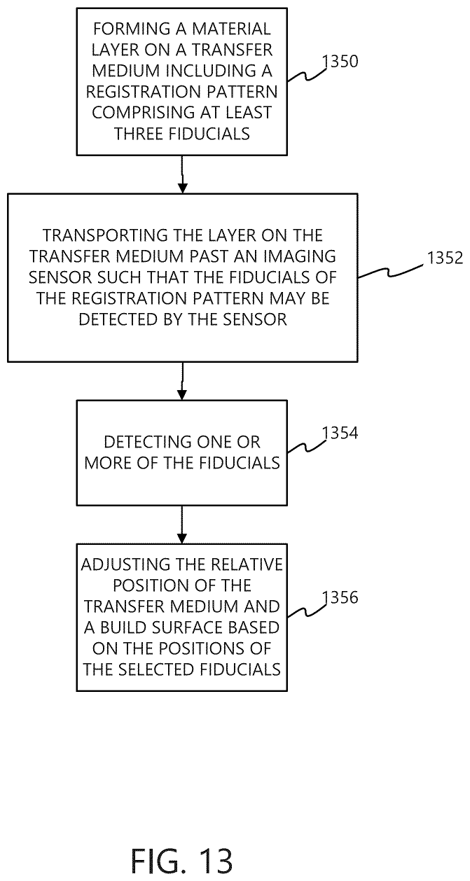

FIG. 13 is a flowchart of a method in accordance with various embodiments herein, showing steps that include, without limitation, forming a material toner image on a transfer medium including a registration pattern comprising at least three features 1350; transporting the toner image on the transfer medium past an imaging sensor such that the features of the registration pattern may be detected by the sensor 1352; detecting one or more of the features 1354; adjusting the relative position of the transfer medium and a build surface based on the positions of the selected features 1356.

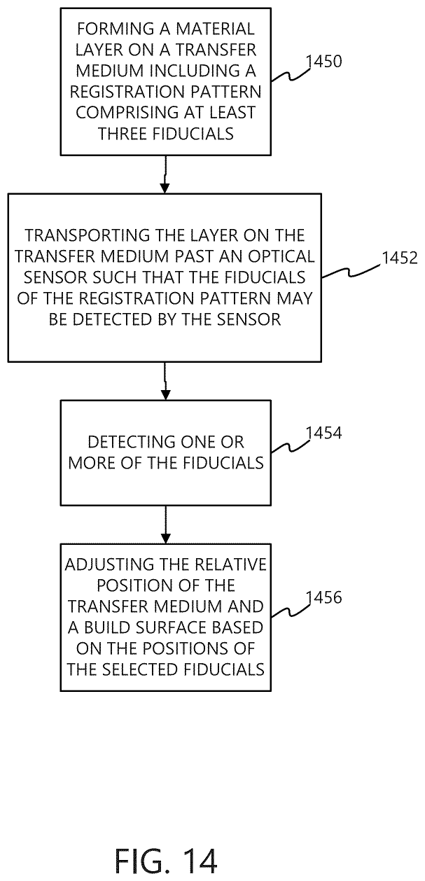

FIG. 14 is a flowchart of a method in accordance with various embodiments herein, showing steps that include, without limitation, forming a material toner image on a transfer medium including a registration pattern comprising at least three features 1450; transporting the toner image on the transfer medium past an optical sensor such that the features of the registration pattern may be detected by the sensor 1452; detecting one or more of the features 1454; adjusting the relative position of the transfer medium and a build surface based on the positions of the selected features 1456.

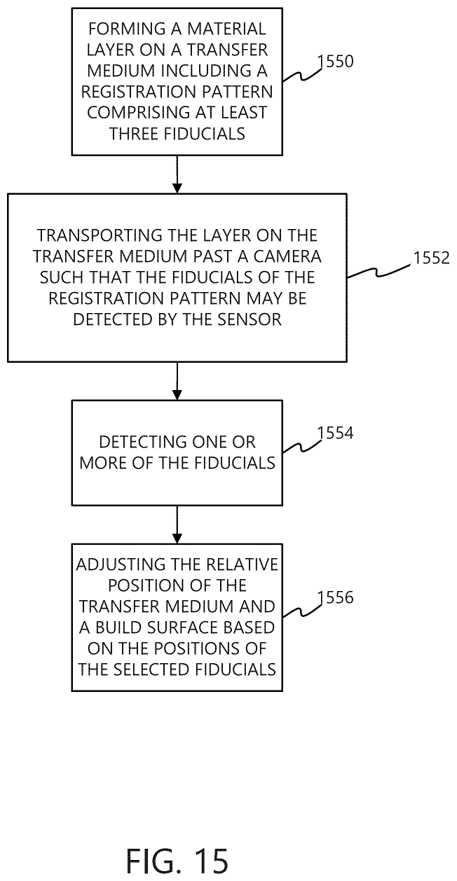

FIG. 15 is a flowchart of a method in accordance with various embodiments herein, showing steps that include, without limitation, forming a material toner image on a transfer medium including a registration pattern comprising at least three features 1550; transporting the toner image on the transfer medium past a camera such that the features of the registration pattern may be detected by the sensor 1552; detecting one or more of the features 1554; adjusting the relative position of the transfer medium and a build surface based on the positions of the selected features 1556.

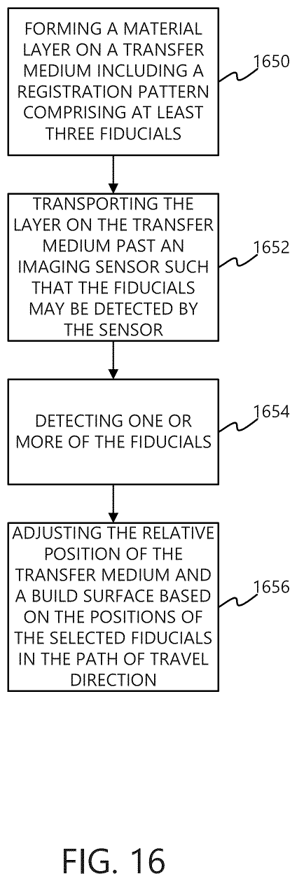

FIG. 16 is a flowchart of a method in accordance with various embodiments herein, showing steps that include, without limitation, forming a material toner image on a transfer medium including a registration pattern comprising at least three features 1650; transporting the toner image on the transfer medium past an imaging sensor such that the features of the registration pattern may be detected by the sensor 1652; detecting one or more of the features 1654; adjusting the relative position of the transfer medium and a build surface based on the positions of the selected features in the path of travel direction 1656.

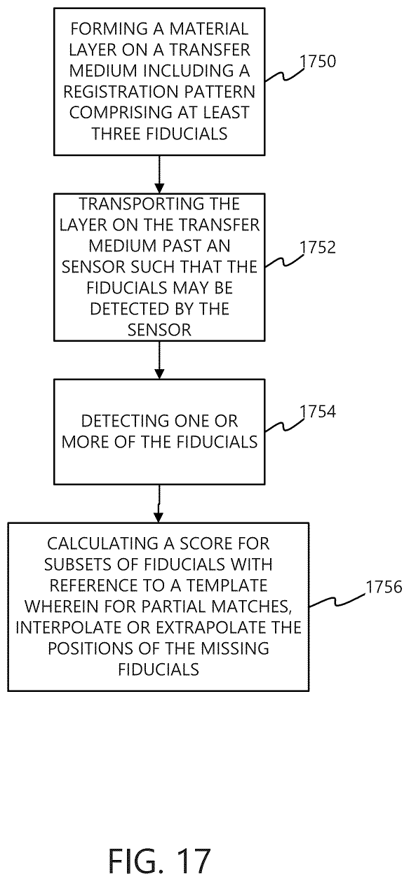

FIG. 17 is a flowchart of a method in accordance with various embodiments herein, showing steps that include, without limitation, forming a material toner image on a transfer medium including a registration pattern comprising at least three features 1750; transporting the toner image on the transfer medium past an sensor such that the features of the registration pattern may be detected by the sensor 1752; detecting one or more of the features 1754; calculating a score for subsets of features with reference to a template wherein for partial matches, interpolate or extrapolate the positions of the missing features 1754.

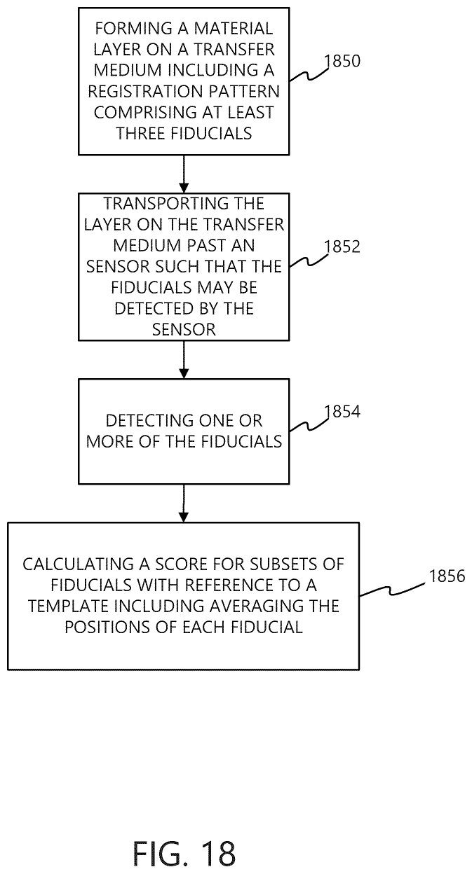

FIG. 18 is a flowchart of a method in accordance with various embodiments herein, showing steps that include, without limitation, forming a material toner image on a transfer medium including a registration pattern comprising at least three features 1850; transporting the toner image on the transfer medium past an sensor such that the features of the registration pattern may be detected by the sensor 1852; detecting one or more of the features 1854; calculating a score for subsets of features with reference to a template including averaging the positions of each feature 1856.

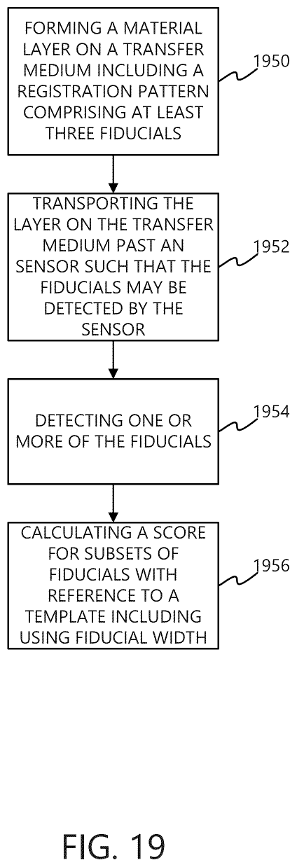

FIG. 19 is a flowchart of a method in accordance with various embodiments herein, showing steps that include, without limitation, forming a material toner image on a transfer medium including a registration pattern comprising at least three features 1950; transporting the toner image on the transfer medium past an sensor such that the features of the registration pattern may be detected by the sensor 1952; detecting one or more of the features 1954; calculating a score for subsets of features with reference to a template including using feature width 1956.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A method for printing a three-dimensional part on a build surface, the method comprising:
a) forming a material toner image on a transfer medium including a registration pattern comprising at least three features;
b) transporting the material toner image on the transfer medium to a sensor such that the features of the registration pattern may be detected by the sensor;
c) detecting one or more of the features;
d) storing a position measurement for each feature detected by the sensor;
e) calculating a score for subsets of features with reference to a template;
f) adjusting the relative position of the transfer medium and a build surface based on the positions of the selected features; and
g) transferring the toner image from the transfer medium to the build surface.

2. The method for printing a three-dimensional part of claim 1, further comprising transfusing the transferred toner image to a part forming on the build surface.

3. The method for printing a three-dimensional part of claim 1, further comprising detecting one or more fiducials for each material toner image.

4. The method for printing a three-dimensional part of claim 1, further comprising repeatedly calculating a score for subsets of artifacts with reference to a template.

5. The method for printing a three-dimensional part of claim 1, wherein the material toner image comprises part material.

6. The method for printing a three-dimensional part of claim 1, wherein the material toner image comprises support material.

7. The method for printing a three-dimensional part of claim 1, wherein the registration pattern comprises four or more features.

8. The method for printing a three-dimensional part of claim 1, wherein the registration pattern is positioned to correspond to one quadrant of the build surface.

9. The method for printing a three-dimensional part of claim 1, wherein the registration pattern is positioned to correspond to two quadrants of the build surface.

10. The method for printing a three-dimensional part of claim 1, wherein the registration pattern is positioned to correspond to three quadrants of the build surface.

11. The method for printing a three-dimensional part of claim 1, wherein the registration pattern is positioned to correspond to all four quadrants of the build surface.

12. The method for printing a three-dimensional part of claim 1, wherein the transfer medium comprises a belt.

13. The method for printing a three-dimensional part of claim 1, wherein the three features are identical to one another.

14. The method for printing a three-dimensional part of claim 1, wherein the three features are different from one another.

15. The method for printing a three-dimensional part of claim 1, wherein the sensor comprises an imaging sensor.

16. The method for printing a three-dimensional part of claim 15, wherein the imaging sensor comprises a camera.

17. The method for printing a three-dimensional part of claim 1, wherein the sensor comprises a capacitive sensor.

18. The method for printing a three-dimensional part of claim 1, wherein adjusting the relative position of the transfer medium and build surface comprises adjustment in the path of direction of travel.

19. The method for printing a three-dimensional part of claim 1, further comprising creating a template with “n” features, where n>3.

20. The method for printing a three-dimensional part of claim 1, further comprising recording a list of N=C_2\hat{ }n target gap sizes between features.

21.-30. (canceled)
